(19) United States
(12) Patent Application Publication
(10) Pub. No.: US 2006/0021980 A1
(43) Pub. Date: Feb. 2, 2006

(54) System and method for controlling a power distribution within a microwave cavity

(76) Inventors: Sang Hun Lee, Austin, TX (US); Jay Joongsoo Kim, San Jose, CA (US)

Correspondence Address: SMITH PATENT OFFICE, 1901 PENNSYLVANIA AVENUE N W, SUITE 901, WASHINGTON, DC, 20006, US

(21) Appl. No.: 10/902,433

(22) Filed: Jul. 30, 2004

(51) Int. Cl. H05B 6/74

(52) U.S. Cl. 219/747; 422/21; 422/186

(57) ABSTRACT

Systems and methods for controlling a power distribution in a microwave cavity are disclosed. The present invention provides a system that includes a microwave source and a pair of isolators that dissipate retrogressing microwaves that travel toward the microwave source. The isolators are connected to the microwave source. The system also includes a microwave cavity having a pair of inlets disposed on opposite sides of the microwave cavity, a pair of waveguides operatively connected to the inlets to the isolators, respectively; a pair of non-rotating phase shifters operatively connected to the waveguides and the isolators, respectively; a pair of circulators operatively connected to the waveguides and being configured to direct the microwaves to the pair of non-rotating phase shifters, respectively. A power distribution within the microwave cavity is controlled by operation of at least one of the pair of non-rotating phase shifters.

### CROSS REFERENCE TO RELATED APPLICATIONS

This application is a related to concurrently filed U.S. application Ser. No. ______, filed on Jul. 30, 2004, entitled “PLASMA NOZZLE ARRAY FOR PROVIDING UNIFORM SCALABLE MICROWAVE PLASMA GENERATION” which is hereby incorporated by reference in its entirety.

### BACKGROUND OF THE INVENTION

1. Field of the Invention

The present invention relates to plasma generating systems, and more particularly to devices and methods for deterministically controlling power distribution within a microwave cavity.

2. Discussion of the Related Art

In recent years, the progress on producing plasma has been increasing. Typically, plasma consists of positive charged ions, neutral species and electrons. In general, plasmas may be subdivided into two categories: thermal equilibrium and thermal non-equilibrium plasmas. Thermal equilibrium implies that the temperature of all species including positive charged ions, neutral species, and electrons, is the same.

Plasmas may also be classified into local thermal equilibrium (LTE) and non-LTE plasmas, where this subdivision is typically related to the pressure of the plasmas. The term “local thermal equilibrium (LTE)” refers to a thermodynamic state where the temperatures of all of the plasma species are the same in the localized areas in the plasma.

A high plasma pressure induces a large number of collisions per unit time interval in the plasma, leading to sufficient energy exchange between the species comprising the plasma, and this leads to an equal temperature for the plasma species. A low plasma pressure, on the other hand, may yield one or more temperatures for the plasma species due to insufficient collisions between the species of the plasma.

In non-LTE, or simply non-thermal plasmas, the temperature of the ions and the neutral species is usually less than 100° C., while the temperature of electrons can be up to several tens of thousand degrees in Celsius. Therefore, non-LTE plasma may serve as highly reactive tools for powerful and also gentle applications without consuming a large amount of energy. This “hot coolness” allows a variety of processing possibilities and economic opportunities for various applications. Powerful applications include metal deposition systems and plasma cutters, and gentle applications include plasma surface cleaning systems and plasma displays.

One of these applications is plasma sterilization, which uses plasma to destroy microbial life, including highly resistant bacterial endospores. Sterilization is a critical step in ensuring the safety of medical and dental devices, materials, and fabrics for final use. Existing sterilization methods used in hospitals and industries include autoclaving, ethylene oxide gas (EtO), dry heat, and irradiation by gamma rays or electron beams. These technologies have a number of problems that must be dealt with and overcome and these include issues such as thermal sensitivity and destruction by heat, the formation of toxic byproducts, the high cost of operation, and the inefficiencies in the overall cycle duration. Consequently, healthcare agencies and industries have long needed a sterilizing technique that could function near room temperature and with much shorter times without inducing structural damage to a wide range of medical materials including various heat sensitive electronic components and equipment.

Atmospheric pressure plasmas for sterilization, as in the case of material processing, offer a number of distinct advantages to users. Its compact packaging makes it easily configurable, it eliminates the need for highly priced vacuum chambers and pumping systems, it can be installed in a variety of environments without additional facilitation needs, and its operating costs and maintenance requirements are minimal. In fact, the fundamental importance of atmospheric plasma sterilization lies in its ability to sterilize heat-sensitive objects, simple-to-use, and faster turnaround cycle. Atmospheric plasma sterilization may be achieved by the direct effect of reactive neutrals, including atomic oxygen and hydroxyl radicals, and plasma generated UV light, all of which can attack and inflict damages to bacteria cell membranes. Thus, there is a need for devices that can generate atmospheric pressure plasma as an effective and low-cost sterilization source.

One of the key factors that affect the efficiency of atmospheric plasma sterilization systems, as in the case of other plasma generating systems, is scalability of plasmas generated by the systems. There are several microwave nozzle based atmospheric pressure plasma systems widely used in the industrial and educational institutions around the world. The most of these designs are single nozzle based and they lack large volume scalability required for sterilization of medical devices applications.

To provide the volume scalability, some of the existing plasma generating systems in the semiconductor industry use nozzle arrays instead of a large single nozzle. However, existing plasma nozzle arrays generate non-uniform plasma, and as a consequence, they need extra systems to provide a uniform application of plasma, such as a turntable where a semiconductor wafer is mounted. As is well known, an incomplete sterilization due to plasma non-uniformity can be detrimental to the users of sterilized articles, and at worst, such systems may be useless. In addition, such nozzle arrays are operated in low-pressure chambers.

One solution to provide uniform plasma may be a nozzle array coupled to a microwave cavity. One of the challenging problems of such system is controlling the microwave distribution within the microwave cavity so that the microwave energy (or, equivalently microwave) is localized at intended regions (hereinafter, referred to as “high-energy regions”) that are stationary within the cavity. In such systems, plasma uniformity and scalability may be obtained by coupling nozzles to the controlled high-energy spots, which also enhances the operational efficiency of the system.

Most of the conventional systems having a microwave cavity are designed to provide a uniform microwave energy distribution in the microwave cavity. For example, Gerling, “WAVEGUIDE COMPONENTS AND CONFIGURATIONS FOR OPTIMAL PERFORMANCE IN MICROWAVE HEATING SYSTEMS,” published on www.2450mhz.com by Gerling Applied Engineering Inc. in 2000, teaches a system having two rotating phase shifters. In this system, the two rotating phase shifters generate high-energy regions that continuously move within the microwave cavity to insure a uniform heating distribution within the microwave cavity.

In contrast to such conventional systems, a plasma generating system that has a plasma nozzle array should be able to deterministically control the microwaves in the microwave cavity and generate high-energy regions coupled to the nozzle array. Thus, there is a strong need for plasma generating systems that can deterministically control the microwave power distribution within the microwave cavities.

### SUMMARY OF THE INVENTION

The present invention provides various systems and methods for deterministically controlling the microwave power distribution within a microwave cavity. This includes providing two or more microwaves that travel in opposite or normal directions to each other within the microwave cavity and interfere with each other to form high-energy regions that are stationary within the microwave cavity.

According to one aspect of the present invention, a microwave generating system, comprises: a microwave source; a pair of isolators operatively connected to the microwave source; a microwave cavity having a pair of inlets; a pair of waveguides, each of the waveguides being operatively connected to at least one of the isolators and to at least one of the inlets of the microwave cavity; and a pair of non-rotating phase shifters, each of the non-rotating phase shifters being operatively connected to at least one of the waveguides and one of the isolators.

According to another aspect of the present invention, a microwave generating system, comprising a microwave source; an isolator operatively connected to the microwave source; a microwave cavity having an inlet; a waveguide operatively connected to the isolator and the inlet of the microwave cavity; a non-rotating phase shifter operatively connected to the waveguide and the isolator; and a sliding short circuit operatively connected to the microwave cavity.

According to still another aspect of the present invention, a microwave generating system includes: a microwave source; a pair of isolators operatively connected to the microwave source, a microwave cavity having a pair of inlets disposed normal to each other; a pair of waveguides, each of the waveguides being operatively connected to at least one of the isolators and to at least one of the inlets of the microwave cavity; a pair of non-rotating phase shifters, each of the non-rotating phase shifters being operatively connected to at least one of the waveguides and one of the isolators; and a pair of sliding short circuits operatively connected to the microwave cavity. The power distribution within the microwave cavity is controlled by operation of at least one of the phase controlling units, where the phase controlling units include the pair of non-rotating phase shifters and the pair of sliding short circuits.

According to still another aspect of the present invention, a microwave generating system includes: a microwave source; a microwave cavity having four inlets; four waveguides, each of the waveguides being operatively connected to one of the inlets of the microwave cavity and to the microwave source; and four non-rotating phase shifters, each of the non-rotating phase shifters being operatively connected to at least one of the waveguides and the microwave source.

According to another aspect of the present invention, a method for generating and controlling at least one high-energy region within a microwave cavity, includes the steps of: generating microwaves; directing the microwaves into a microwave cavity in opposing directions such that the microwaves interfere with each other and form a standing microwave pattern within the microwave cavity; and controlling at least one high-energy region generated by the standing microwave pattern by adjusting at least one phase of the microwaves.

According to another aspect of the present invention, a method for generating and controlling high-energy regions within a microwave cavity includes the steps of: directing a first pair of microwaves into a microwave cavity in opposing directions along a first axis; directing a second pair of microwaves into the microwave cavity in opposing directions along a second axis, the first axis being normal to the second axis such that the first and the second pair of microwaves interfere to yield high-energy regions that are stationary within the microwave cavity; and adjusting a phase of at least one selected from the first and second pairs of microwaves to control the high-energy regions.

These and other advantages and features of the invention will become apparent to those persons skilled in the art upon reading the details of the invention as more fully described below.

### BRIEF DESCRIPTION OF THE DRAWINGS

FIG. 1 is a schematic diagram of a system for deterministically generating high-energy regions within a microwave cavity in accordance with one embodiment of the present invention.

FIG. 2A schematically illustrates the interference of two microwaves within the microwave cavity of the system shown in FIG. 1, where the microwaves travel in opposing directions.

FIG. 2B schematically shows a distribution of high-energy regions within the microwave cavity shown in FIG. 2A.

FIG. 3 is a schematic diagram of a system for deterministically generating high-energy regions within a microwave cavity in accordance with another embodiment of the present invention.

FIG. 4 is a schematic diagram of a system for deterministically generating high-energy regions in a two-dimensional array form within a microwave cavity in accordance with another embodiment of the present invention.

FIG. 5 schematically illustrates a pattern of all of the regions including the high-energy regions established within the microwave cavity of the system shown in FIG. 4.

FIG. 6 is a schematic diagram of a microwave cavity and waveguides for generating high-energy regions in a two-dimensional array form in accordance with another embodiment of the present invention.

FIG. 7 shows a flow chart illustrating the exemplary steps for generating and controlling high-energy regions within a microwave cavity in accordance with at least one embodiment of the present invention.

### DETAILED DESCRIPTION OF THE PREFERRED EMBODIMENTS

As mentioned, conventional microwave plasma systems generate a uniform power distribution within a microwave cavity by controlling the phase differences between two microwaves transmitted to the microwave cavity. Unlike existing systems, the present invention provides methods and systems for controlling the phases of a plurality of microwaves so that they generate stationary high-energy regions within the microwave cavity.

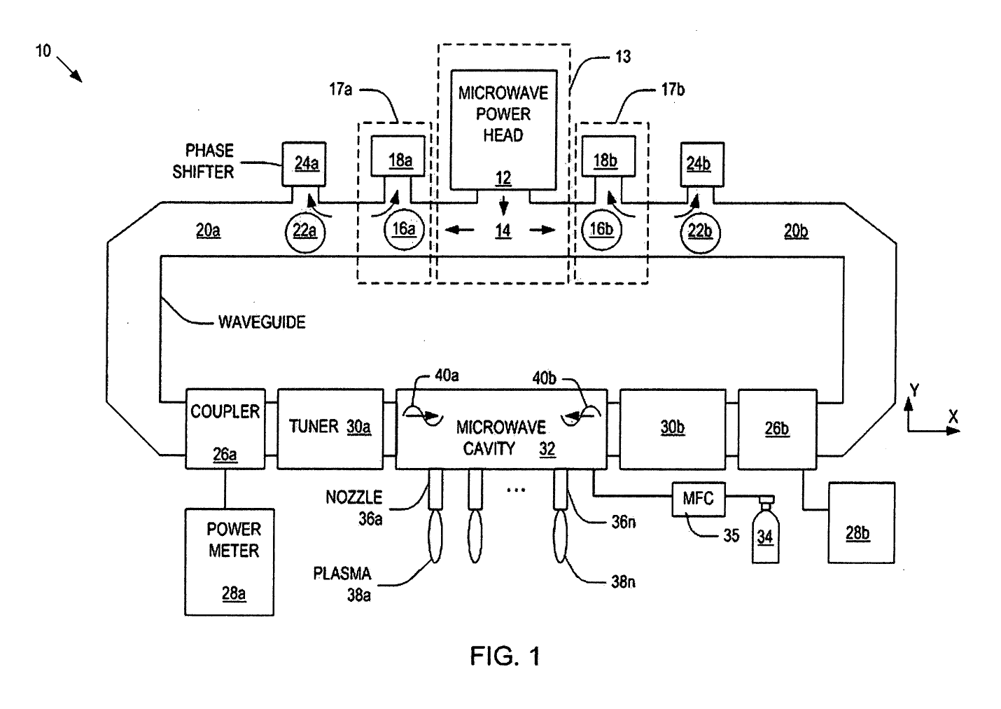

FIG. 1 is a schematic diagram of a system 10 for deterministically generating high-energy regions within a microwave cavity in accordance with one embodiment of the present invention. As illustrated, the system 10 includes a microwave source 13 having a microwave power head 12 that generates microwaves and a power splitter 14 having two outlets that splits the microwaves generated by the microwave power head 12; a pair of isolators 17a and 17b configured to dissipate the retrogressing microwaves that travel toward the microwave power head 12, each isolator including a dummy load 18a and 18b for dissipating the retrogressing microwaves and a circulator 16a and 16b for diverting the retrogressing microwaves to a corresponding dummy load 18a and 18b; a pair of non-rotating phase shifters 24a and 24b for shifting the phases of the microwaves; a pair of circulators 22a and 22b for directing the microwaves from the power slitter 14 to non-rotating phase shifters 24a and 24b, respectively; waveguides 20a and 20b for transmitting microwaves; and a microwave cavity 32. In one embodiment, the system 10 may further include couplers 26a and 26b connected to power meters 28a and 28b for measuring microwave fluxes; and tuners 30a and 30b for matching the impedance of the microwaves. Each of the tuners 30a and 30b should be connected to a corresponding one of the waveguides 20a and 20b and located close to the microwave cavity 32. The tuners 30a and 30b can be operatively connected to the microwave cavity 32 but the tuners 30a and 30b are not necessarily directly connected to the microwave cavity 32. Thus, each of the tuners 30a and 30b is near or in proximity to the microwave cavity 32. This is also true for the other tuners discussed in the other embodiments below.

Typically, the microwave power head 12 includes a microwave generator and a power supply, which are not shown in FIG. 1 for simplicity. In another embodiment, an isolator may be located between the microwave power head 12 and the power splitter 14, thereby replacing the pair of isolators 17a and 17b.

One or more nozzles 36a-n may be connected to the microwave cavity 32 and generate plasma plumes 38a-n from a gas provided from a gas tank 34 through a mass flow control (MFC) valve 35. The nozzles 36a-n may be of any design, as long as they can be incorporated into the microwave cavity 32 and generate plasma plumes 38a-n using the microwaves in the microwave cavity 32.

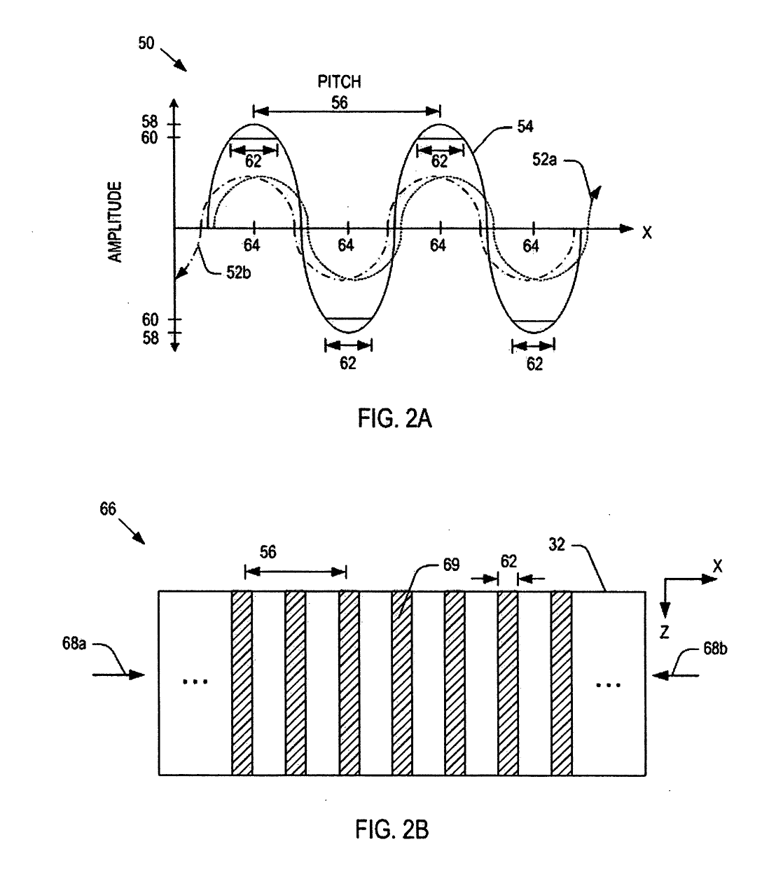

As shown in the inset diagrams 40a and 40b, microwaves transmitted from the power splitter 14 travel in opposing directions along an x-axis within the microwave cavity 32 and yield an interference pattern, as shown in FIG. 2A. FIG. 2A shows a plot 50 of two microwaves 52a and 52b that interfere with each other to yield a standing microwave 54 within the microwave cavity 32. The abscissa and ordinate of the plot 50 represent the direction of the microwave propagations and the amplitude of microwaves, respectively. Since the intensity of the standing microwave 54 is proportional to the square of the amplitude, the standing microwave 54 has two peak locations 64 for each cycle where the amplitude the reaches its maximum amplitude 58. (For simplicity, hereinafter, the amplitude refers to the absolute value of amplitude.) High-energy regions 62 are shown where the amplitude of the standing microwave 54 exceeds the threshold 60 that is set by a user.

Peak locations 64 and maximum amplitudes 58 of the peaks as well as the high-energy regions 62 may be controlled by the non-rotating phase shifters 24a and 24b, while the pitch 56 is determined by the wavelength of the two microwaves 52a and 52b. If the phase difference between the two microwaves 52a and 52b decreases, the maximum amplitude 58 and the width of the high-energy regions 62 increase. If the phases of the two microwaves 52a and 52b are shifted in one direction along the x-axis, the peak locations 64 may shift in that direction.

FIG. 2B shows a distribution 66 of the high-energy regions 69 within the microwave cavity 32 when viewed in a direction normal to the x-z plane. As shown in FIG. 2B, the high-energy regions 69 are generated by interference of the two microwaves 52a and 52b propagating in directions 68a and 68b, respectively, within the microwave cavity 32. As the microwaves 52a and 52b may be one-dimensional waves, each of high-energy regions 69 may be in a rectangular strip shape and spaced by half of the pitch 56. In FIGS. 2A-B, the microwave cavity is assumed to be a rectangular parallelepiped structure for the purpose of illustration. However, it should be apparent to those of ordinary skill in the art that microwave cavity can have any other shape without deviating from the present invention.

In an alternative embodiment, the microwave source 13 may be replaced by two separate microwave power heads and two isolators attached thereto, respectively, where each microwave power head may transmit microwaves to the microwave cavity 32. In this embodiment, two microwaves 52a and 52b may have different wavelengths and amplitudes. However, by applying the same principles set forth above, the non-rotating phase shifters 24a and 24b can be used to control the peak locations 64 and the maximum amplitude 58 as well as the width of the high-energy regions 62.

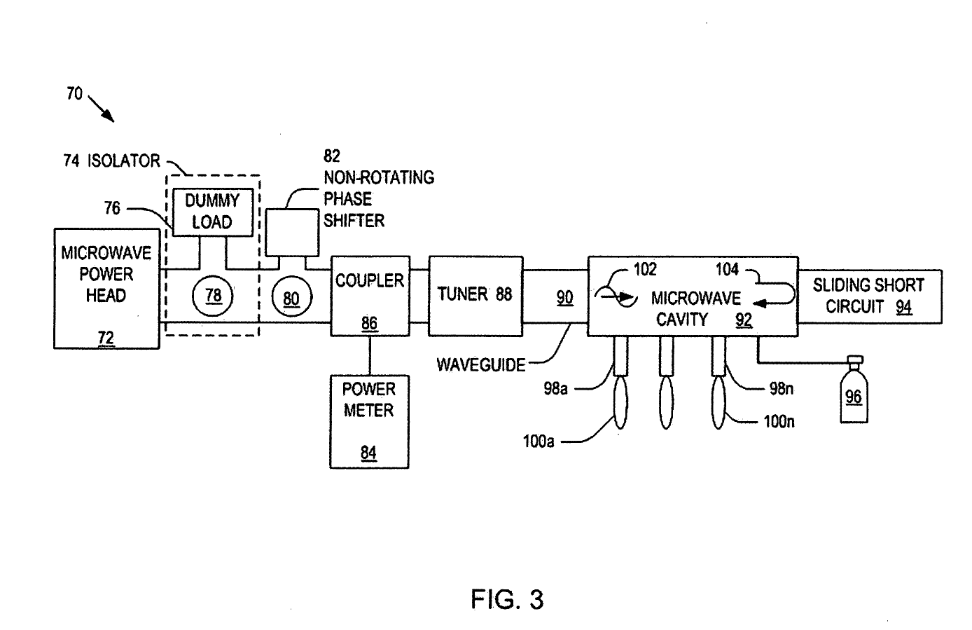

FIG. 3 is a schematic diagram of a system 70 for deterministically generating high-energy regions within a microwave cavity in accordance with another embodiment of the present invention. As illustrated, the system 70 may include a microwave power head 72 for generating microwaves; an isolator 74 having a dummy load 76 configured to dissipate retrogressing microwaves that propagate toward the microwave power head 72 and a circulator 78 for diverting the retrogressing microwaves to a dummy load 76; a non-rotating phase shifter 82 for controlling the microwave phase; a circulator 80; the microwave cavity 92; a waveguide 90 for transmitting microwaves from the microwave power head 72 to the microwave cavity 92; and a sliding short circuit 94 for controlling the phase of the reflected microwaves therefrom.

In one embodiment, the system 70 may further include a coupler 86 connected to power meters 84 for measuring microwave fluxes; and tuner 88 for matching the impedance of microwaves. In another embodiment, a sliding short circuit 94 may be replaced by a wall, where the dimension of the microwave cavity 92 along the microwave propagation is a multiple of half a wavelength of the microwaves. One or more nozzles 98a-n may be coupled to the microwave cavity 92 and generate plasma plumes 100a-n from a gas provided from the gas tank 96. As in FIG. 1, nozzles 98a-n may be of any design, as long as they can be incorporated into the microwave cavity 92 and generate plasma plumes 100a-n using the microwaves in the microwave cavity 92.

In FIG. 3, inset diagram 102 illustrates the propagation of microwaves transmitted from the microwave power head 72 to the microwave cavity 92. The transmitted microwaves are reflected from the sliding short circuit 94, as indicated by an arrow 104, and they interfere with the incoming microwaves to generate standing microwaves within the microwave cavity 92. The sliding short circuit 94 can control the phase of the reflected microwaves and, if it is used in conjunction with the non-rotating phase shifter 82, it can control the locations and maximum amplitudes of the standing waves as well as the width of high-energy regions that are similar to the high-energy regions 69 of FIG. 2B.

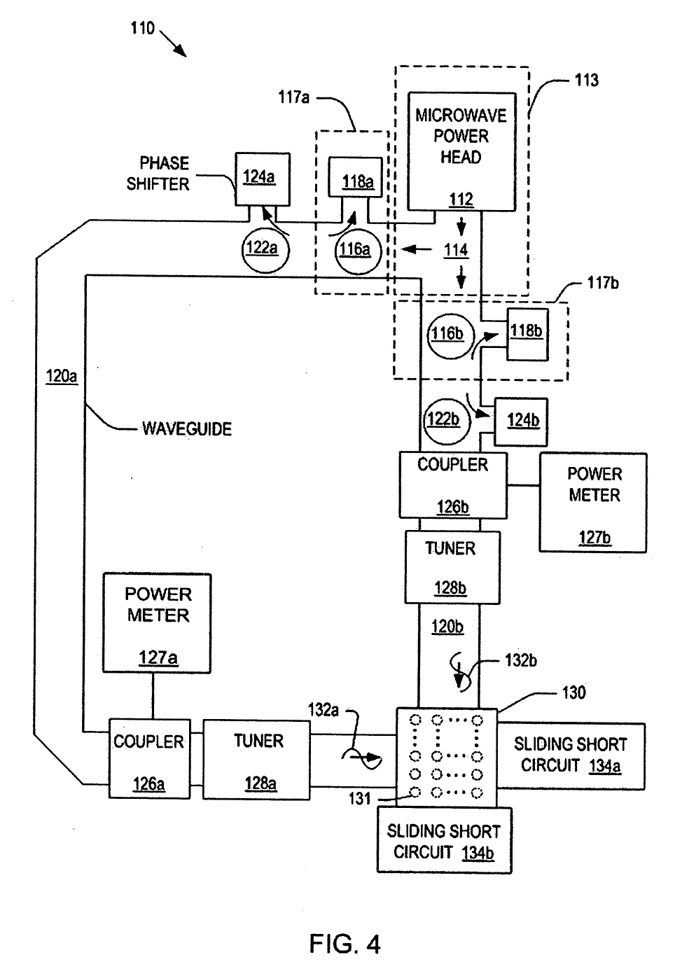

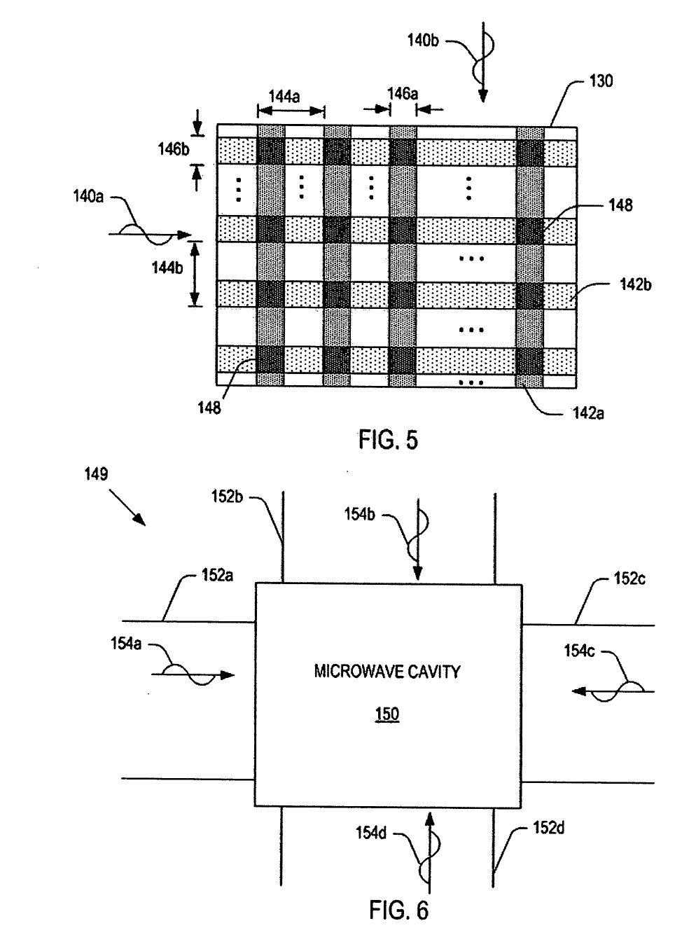

As shown in FIG. 1, an array of the nozzles 36 may be connected to the microwave cavity 32, and more specifically, each nozzle may be configured within the high-energy regions 69 to maximize the use of microwave energy within the microwave cavity 32. In general, an operational efficiency of the microwave cavity 32 may increase if the size of each high-energy region 69 approaches to that of the nozzle 36a. As the cross section of typical nozzle is a circle or a rectangle with an aspect ratio of near unity, an operational efficiency of the microwave cavity may be maximized if high-energy regions are confined within the rectangular regions in a 2-dimensional matrix form as will be described in FIGS. 4 and 5.

FIG. 4 is a schematic diagram of a system 110 for deterministically generating high-energy regions in a 2-dimensional array form within a microwave cavity in accordance with one embodiment of the present invention. The components of the system 100 are similar to their counterparts of FIG. 1, except that two microwaves 132a and 132b are traveling normal to each other in a microwave cavity 130. As illustrated, the system 110 includes: a microwave source 113 that has a microwave power head 112 and a power splitter 114 having two outlets; a pair of non-rotating phase shifters 124a and 124b; a pair of isolators 117a and 117b including a pair of circulators 116a and 116b and a pair of dummy loads 118a and 118b; a pair of circulators 122a and 122b; a waveguides 120a and 120b; a microwave cavity 130; and a pair of sliding short circuits 134a and 134b. In one embodiment, the system 110 may further include: a pair of couplers 126a and 126b; a pair of tuners 128a and 128b; and a pair of power meters 127a and 127b connected to the pair of couplers 126a and 126b, respectively. Also, one or more nozzles 131 may be coupled to a microwave cavity and generate plasma plumes from a gas provided from a gas tank, where the nozzles 131 that may be of any design, as long as they can be incorporated into the microwave cavity 130 and generate plasma plumes (not shown in FIG. 4) using the microwaves in the microwave cavity 130. In another embodiment, an isolator may be located between the microwave power head 112 and the power splitter 114, replacing the pair of isolators 117a and 117b.

FIG. 5 illustrates a pattern of high-energy regions established within the microwave cavity 130 of FIG. 4. As shown in FIG. 5, microwaves 140a and 140b, traveling normal to each other, generate high-energy regions in a two-dimensional array form, where intervals 144a and 144b correspond to half-wavelengths of the microwaves 140a and 140b, respectively. By the same principle as applied to the interference pattern generated by the system 70 in FIG. 3, the microwaves 140a and 140b may generate two standing microwaves that a yield strip-shaped high-energy regions 142a and 142b, respectively. Then, the two standing microwaves may further interfere to generate high-energy regions 148 in a matrix form as shown in FIG. 5. Locations and widths 146a and 146b of the high-energy regions may be controlled by the non-rotating phase shifters 124a and 124b and/or the sliding short circuits 134a and 134b.

In an alternative embodiment, the microwave source 113 may be replaced by two separate microwave power heads and two isolators attached thereto, respectively, where each microwave power head may transmit a microwave to the microwave cavity 130. In such an embodiment, two microwaves may have different wavelengths and amplitudes, and as a consequence, the intervals 144a and 144b may be different from each other. Likewise, the widths 146a and 146b may be different from each other.

FIG. 6 is a schematic diagram 149 of a microwave cavity and waveguides for generating high-energy regions in a two-dimensional array form in accordance with another embodiment of the present invention. As illustrated in FIG. 6, a microwave cavity 150 may receive four microwaves 154a-d traveling through four waveguides 152a-d, respectively, and the phase of each microwave may be controlled by a corresponding one of the four non-rotating phase shifters (not shown in FIG. 6) coupled to the waveguides 152a-d. Also, as in the case of 22a and 24a in FIG. 1, the four non-rotating phase shifters may be coupled to four circulators, respectively. The microwaves 154a-d may be generated by one or more microwave power heads. In one embodiment, each of the microwaves 154a-d may be generated by a corresponding one of four microwave power heads. In a further embodiment, microwave power heads generate two microwaves, where each microwave is split into two microwaves by a power splitter. In a still further embodiment, one microwave power head may be split into four microwaves using a four-outlet power splitter. In these three embodiments, one or more isolators may be attached to each microwave power heads to dissipate retrogressing microwaves that travels toward the microwave power head. It is noted that these embodiments are provided for exemplary purposes only. Thus, it should be apparent to one of ordinary skills that a system with a capability to provide the microwaves may be connected to the four microwave waveguides 152a-d without deviating from the present invention.

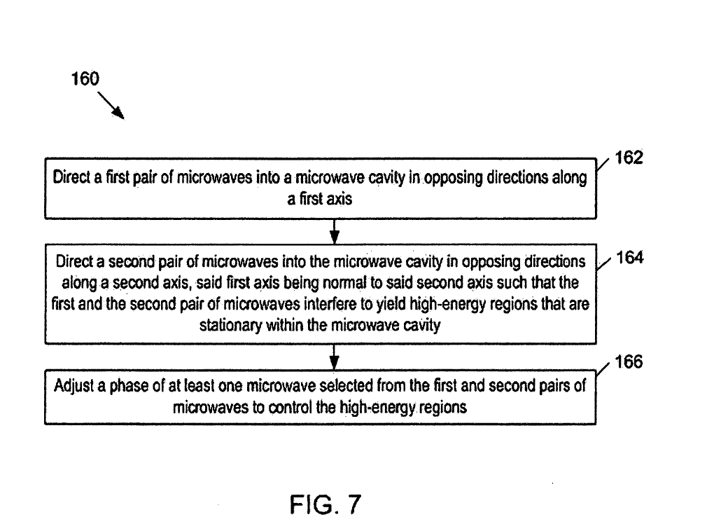

FIG. 7 shows a flow chart 160 illustrating the exemplary steps for generating and controlling high-energy regions within a microwave cavity in accordance with one embodiment of the present invention. At a step 162, a first pair of microwaves may be directed into a microwave cavity in opposing directions along a first axis. Next, at a step 164, a second pair of microwaves may be directed into the microwave cavity in opposing directions along a second axis, where the first axis is normal to the second axis such that the first and the second pair of microwaves interfere to yield high-energy regions that are stationary within the microwave cavity. Then, at step 166, the phase of at least one selected from the first and second pairs of microwaves may be adjusted to control the high-energy regions. The distribution of the high-energy regions generated in the step 166 may be similar to that shown in FIG. 5.

While the present invention has been described with a reference to the specific embodiments thereof, it should be understood, of course, that the foregoing relates to preferred embodiments of the invention and that modifications may be made without departing from the spirit and the scope of the invention as set forth in the following claims.

What is claimed is:

1. A microwave generating system, comprising:
a microwave source;
a pair of isolators operatively connected to said microwave source;
a microwave cavity having a pair of inlets;
a pair of waveguides, each of said waveguides being operatively connected to a corresponding one of said isolators and to a corresponding one of said inlets of said microwave cavity; and
a pair of non-rotating phase shifters, each of said non-rotating phase shifters being operatively connected to a corresponding one of said waveguides and a corresponding one of said isolators.

2. A microwave generating system as defined in claim 1, further comprising:
a pair of circulators, each of said circulators being operatively connected to a corresponding one of said waveguides and being configured to direct microwaves to a corresponding one of said non-rotating phase shifters.

3. A microwave generating system as defined in claim 1, wherein each of said isolators comprises:
a circulator operatively connected to a corresponding one of said waveguides; and
a dummy load operatively connected to said circulator.

4. A microwave generating system as defined in claim 1, further comprising:
a pair of tuners, each of said tuners being operatively connected to a corresponding one of said waveguides in proximity to said microwave cavity.

5. A microwave generating system as defined in claim 1, further comprising:
a pair of couplers, each of said couplers being operatively connected to a corresponding one of said waveguides and a power meter for measuring microwave fluxes.

6. A microwave generating system as defined in claim 1, wherein said microwave source comprises two microwave power heads, each of said microwave power heads being operatively connected to a corresponding one of said isolators.

7. A microwave generating system as defined in claim 1, wherein said microwave source comprises:
a microwave power head for generating source microwaves; and
a power splitter for receiving, bisecting and directing the source microwaves to said pair of isolators.

8. A microwave generating system as defined in claim 1, wherein the microwaves received through said inlets interfere and form at least one stationary high-energy region within said microwave cavity.

9. A microwave generating system, comprising:
a microwave source;
an isolator operatively connected to said microwave source;
a microwave cavity having an inlet;
a waveguide operatively connected to said isolator and said inlet of said microwave cavity;
a non-rotating phase shifter operatively connected to said waveguide and said isolator; and
a sliding short circuit operatively connected to said microwave cavity.

10. A microwave generating system as defined in claim 9, further comprising:
a circulator being operatively connected to said waveguide and being configured to direct microwaves to said non-rotating phase shifter.

11. A microwave generating system as defined in claim 9, wherein said isolator comprises:
a circulator operatively connected to said waveguide; and
a dummy load operatively connected to said circulator.

12. A microwave generating system as defined in claim 9, further comprising:
a tuner, said tuner being operatively connected to said waveguide in proximity to said microwave cavity.

13. A microwave generating system as defined in claim 9, further comprising:
a coupler operatively connected to said waveguide and a power meter for measuring microwave fluxes.

14. A microwave generating system as defined in claim 9, wherein the microwaves received through said inlet interfere with reflected microwave and form at least one stationary high-energy region within said microwave cavity.

15. A microwave generating system, comprising:
a microwave source;
a pair of isolators operatively connected to said microwave source;
a microwave cavity having a pair of inlets disposed normal to each other;
a pair of waveguides, each of said waveguides being operatively connected to a corresponding one of said isolators and to a corresponding one of said inlets of said microwave cavity;
a pair of non-rotating phase shifters, each of said non-rotating phase shifters being operatively connected to a corresponding one of said waveguides and a corresponding one of said isolators; and
a pair of sliding short circuits operatively connected to said microwave cavity.

16. A microwave generating system as defined in claim 15, further comprising:
a pair of circulators, each of said circulators being operatively connected to a corresponding one of said waveguides and being configured to direct microwaves to a corresponding one of said non-rotating phase shifters.

17. A microwave generating system as defined in claim 15, wherein each of said isolators comprises:
a circulator operatively connected to a corresponding one of said waveguides; and
a dummy load operatively connected to said circulator.

18. A microwave generating system as defined in claim 15, further comprising:
a pair of tuners, each of said tuners being operatively connected to a corresponding one of said waveguides in proximity to said microwave cavity.

19. A microwave generating system as defined in claim 15, further comprising:
a pair of couplers, each of said couplers being operatively connected to a corresponding one of said waveguides and a power meter for measuring microwave fluxes.

20. A microwave generating system as defined in claim 15, wherein said microwave source comprises two microwave power heads, each of said microwave power heads being operatively connected to a corresponding one of said isolators.

21. A microwave generating system as defined in claim 15, wherein said microwave source comprises:
a microwave power head for generating source microwaves; and
a power splitter for receiving, bisecting and directing the source microwaves to said pair of isolators.

22. A microwave generating system, comprising:
a microwave source;
a microwave cavity having four inlets;
four waveguides, each of said waveguides being operatively connected to a corresponding one of said inlets of said microwave cavity and to said microwave source; and
four non-rotating phase shifters, each of said non-rotating phase shifters being operatively connected to a corresponding one of said waveguides and said microwave source.

23. A microwave generating system as defined in claim 22, further comprising:
four circulators, each of said circulators being operatively connected to a corresponding one of said waveguides and being configured to direct microwaves to a corresponding one of said non-rotating phase shifters.

24. A microwave generating system as defined in claim 22, wherein said microwave source comprises four microwave power heads; and said microwave generating system further comprises:
four isolators, each of said isolators being operatively connected to a corresponding one of said microwave power heads and to a corresponding one of said waveguides, and wherein each of said isolators includes:
a circulator operatively connected to a corresponding one of said waveguides; and
a dummy load operatively connected to said circulator.

25. A microwave generating system as defined in claim 22, wherein said microwave source comprises two microwave power heads; and said microwave generating system further comprises:
two isolators, each of said isolators being operatively connected to a corresponding one of said microwave power heads, and wherein each of said isolators includes:
a circulator operatively connected to a corresponding one of said waveguides; and
a dummy load operatively connected to said circulator; and
two power splitters, each of said power splitters being operatively connected to a corresponding one of said isolators, and each of said power splitters being configured to receive, bisect and direct microwaves to a corresponding one of said waveguides.

26. A microwave generating system as defined in claim 22, wherein said microwave source comprises a microwave power head; and said microwave generating system further comprises:
an isolator operatively connected to said microwave power head, said isolator includes:
a circulator operatively connected to a corresponding one of said waveguides; and
a dummy load operatively connected to said circulator; and
a power splitter operatively connected to said isolator, said power splitter being configured to receive, split and direct the microwaves to a corresponding one of said waveguides.

27. A microwave generating system as defined in claim 22, further comprising:
four tuners, each of said tuners being operatively connected to a corresponding one of said waveguides in proximity to said microwave cavity.

28. A microwave generating system as defined in claim 22, further comprising:
four couplers, each of said couplers being operatively connected to a corresponding one of said waveguides and a power meter for measuring microwave fluxes.

29. A method for generating and controlling at least one high-energy region within a microwave cavity, said method comprises the steps of:
generating microwaves;
directing the microwaves into a microwave cavity in opposing directions such that the microwaves interfere with each other and form a standing microwave pattern within the microwave cavity; and
controlling at least one high-energy region generated by the standing microwave pattern by adjusting at least one phase of the microwaves.

30. A method as defined in claim 29, wherein said step of directing the microwaves includes the steps of:
transmitting microwaves to the microwave cavity; and
reflecting the microwaves transmitted in said step of transmitting using a sliding short circuit operatively connected to the microwave cavity.

31. A method as defined in claim 29, wherein said step of directing the microwaves includes the step of:
transmitting microwaves generated by two microwave power heads to the microwave cavity.

32. A method for generating and controlling high-energy regions within a microwave cavity, said method comprises the steps of:
directing a first pair of microwaves into a microwave cavity in opposing directions along a first axis;
directing a second pair of microwaves into the microwave cavity in opposing directions along a second axis, the first axis being normal to the second axis such that the first and the second pair of microwaves interfere to yield high-energy regions that are stationary within the microwave cavity; and
adjusting a phase of at least one selected from the first and second pairs of microwaves to control the high-energy regions.

33. A method as defined in claim 32, wherein said step of directing the first pair of microwaves includes said steps of:
transmitting the microwaves to the microwave cavity; and
reflecting the microwaves using a sliding short circuit operatively connected to the microwave cavity.

34. A method as defined in claim 32, wherein said step of directing the first pair of microwaves includes said step of:
transmitting the microwaves generated by two microwave power heads to the microwave cavity.

35. A method as defined in claim 32, wherein the first and second pairs of microwaves are generated by a microwave power head and a power splitter operatively connected to the microwave power head.

36. A microwave generating system, comprising:
a microwave source for generating microwaves;
a pair of isolators operatively connected to said microwave source;
a microwave cavity having a pair of inlets;
a pair of waveguides, each of said waveguides being operatively connected to a corresponding one of said isolators and to a corresponding one of said inlets of said microwave cavity; and
a pair of non-rotating phase shifters for adjusting at least one high-energy region formed by the microwaves to predetermined locations in said microwave cavity, each of said non-rotating phase shifters being operatively connected to a corresponding one of said waveguides and a corresponding one of said isolators.
